(19) United States
(12) Patent Application Publication
(10) Pub. No.: US 2025/0376188 A1
(43) Pub. Date: Dec. 11, 2025

(54) METHOD AND DEVICE WITH DRIVING PATH OPTIMIZATION AND TRAINING FOR SAME

(71) Applicant: Samsung Electronics Co., Ltd., Suwon-si (KR)

(72) Inventor: Dohyun JANG, Suwon-si (KR)

(73) Assignee: Samsung Electronics Co., Ltd., Suwon-si (KR)

(21) Appl. No.: 18/975,580

(22) Filed: Dec. 10, 2024

(30) Foreign Application Priority Data
Jun. 5, 2024 (KR) 10-2024-0073812

(51) Int. Cl. B60W 60/00; B60W 50/00

(52) U.S. Cl. CPC B60W 60/001; B60W 50/0098; B60W 2050/0012; B60W 2050/0031

(57) ABSTRACT

A driving path optimization training method of a vehicle includes: receiving a first data set including a driving path and an associated driving environment information; generating a second data set from the first data by performing data augmentation on the first data; training a driving path planner based on the second data set; and training a driving controller based on a training result of the training of the driving path planner.

### CROSS-REFERENCE TO RELATED APPLICATIONS

This application claims the benefit under 35 USC § 119 (a) of Korean Patent Application No. 10-2024-0073812, filed on Jun. 5, 2024, in the Korean Intellectual Property Office, the entire disclosure of which is incorporated herein by reference for all purposes.

### BACKGROUND

### 1. Field

The following description relates to a method and device with driving path optimization and training for the same.

### 2. Description of Related Art

Recently, motion planning regarding a driving path of autonomous vehicles is being performed based on expert data. An expert data set includes information about surrounding environments obtained by driving experts while driving a vehicle equipped with sensors. For example, information in an expert data set may indicate trajectories of vehicles included in the surrounding environment, surrounding map information, and traffic signal information. Using the expert data, a motion planning model may infer the driving trajectory of experts based on the information about vehicle surroundings obtained by the sensors. However, in actual driving situations, situations that are different from (outside of) the expert data may occur, and therefore, it may be impossible to correctly modify or infer the driving trajectory of a vehicle with a model trained by an expert data set. Therefore, improvement methods may be required to solve these issues.

The above description is information the inventor(s) acquired during the course of conceiving the present disclosure, or already possessed at the time, and is not necessarily art publicly known before the present application was filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a driving path optimization training method of a vehicle includes: receiving a first data set including a driving path and an associated driving environment information; generating a second data set from the first data by performing data augmentation on the first data; training a driving path planner based on the second data set; and training a driving controller based on a training result of the training of the driving path planner.

The first data set may include an expert data set collected by an arbitrary vehicle and data about an optimal path associated with the expert data set.

The performing the data augmentation may include adding noise to a posture, a location, a speed, a steering angle, a steering rate, or acceleration data of the vehicle included in the first data set.

The second data set may include optimal paths generated based on data to which noise is added to the first data set, based on a vehicle dynamics model and an objective function.

The objective function may induce generation of the optimal paths to minimize an error between a target path of the vehicle changed by the noise and an optimal path for the first data set.

The optimal paths may be generated based on a nonlinear optimization method.

The training of the driving path planner may include performing training of the driving path planner based on an open-loop simulation training method.

The training of the driving controller includes performing training of the driving controller may be based on a closed-loop reinforcement training method.

The closed-loop reinforcement training method may include a behavior cloned soft actor-critic (BC-SAC) algorithm.

A non-transitory computer-readable storage medium may store instructions that, when executed by a processor, cause the processor to perform any of the methods.

In another general aspect, an electronic device includes: a memory storing instructions; and one or more processors, wherein the instructions, when executed by the one or more processors, cause the one or more processors to: receive a first data set including a driving path and an associated driving environment information; generate a second data set from the first data set by performing data augmentation on the first data set; train a driving path planner based on the second data set; and train a driving controller based on a training result of the driving path planner.

The first data set may include an expert data set collected by an arbitrary vehicle and data about an optimal path associated with the expert data set.

The performing the data augmentation may include adding noise to a posture, a location, a speed, a steering angle, a steering rate, or acceleration data of a vehicle included in the first data set.

The second data set may include optimal paths generated based on data to which noise is added to the first data set, based on a vehicle dynamics model and an objective function.

The objective function may induce generation of the optimal path data to minimize an error between a target path of a vehicle changed by the noise and an optimal path for the first data set.

The optimal paths may be generated based on a nonlinear optimization method.

The instructions, when executed by the one or more processors, may cause the one or more processors to perform training of the driving path planner based on an open-loop imitation training method.

The instructions, when executed by the one or more processors, may cause the one or more processors to perform training of the driving controller based on a closed-loop reinforcement training method.

The closed-loop reinforcement training method may include a behavior cloned soft actor-critic (BC-SAC) algorithm.

In another general aspect, a vehicle includes: a memory storing instructions; and one or more processors configured by the instructions to execute a driving path planner and a driving controller, wherein the driving path planner is configured to: receive a first data set including a driving path and an associated driving environment information; generate a second data set from the first data set by performing data augmentation on the first data set; and be trained based on the second data set; and wherein the driving controller is configured to be trained based on the driving path planner as trained based on the second data set.

Other features and aspects will be apparent from the following detailed description, the drawings, and the claims.

### BRIEF DESCRIPTION OF THE DRAWINGS

FIG. 1 illustrates an example driving path optimization method of a vehicle, according to one or more embodiments.

FIG. 2 illustrates an example data generator, according to one or more embodiments.

FIG. 3 illustrates an example of data augmentation, according to one or more embodiments.

FIG. 4 illustrates an example of noising data augmentation, according to one or more embodiments.

FIG. 5 illustrates an example dynamics model of a vehicle, according to one or more embodiments.

FIG. 6 illustrates an example of training a planner, according to one or more embodiments.

FIG. 7 illustrates an example of operation of a planner, according to one or more embodiments.

FIG. 8 illustrates an example of training a controller, according to one or more embodiments.

FIG. 9 illustrates an example of a simulation result of using a driving path optimization method of a vehicle, according to one or more embodiments.

FIG. 10 illustrates an example an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

A system of a vehicle that performs autonomous (or assisted) driving may include a cognitive system, a trajectory generation system, and a vehicle control system. The cognitive (learning) system may recognize surrounding environments through sensors (e.g. cameras and light detection and ranging (LiDAR)) attached to the vehicle. The path generation system may generate a driving target path for a vehicle based on results recognized through the cognitive system. The control system may drive the vehicle based on the driving path and information about surroundings of the vehicle.

In an autonomous driving system, components thereof, including a control system, may operate as a closed-loop system. Because of the closed-loop operation, errors generated in the component systems may cause errors in the control system to increase. For example, when an error occurs in a path generation system, errors increase in the control system due to incorrect target path transmission and this may cause negative feedback in which errors in the path generation system increase. Therefore, when an error occurs in the control system, the distribution of training data previously used to train the path generation system deviates from the actual behavior of the autonomous driving system and the errors in the path generation system continue to increase, which may cause the error in the control system to increase. Therefore, for the path generation system to improve the performance of the autonomous driving system, the path generation system may benefit from learning from training data that includes errors.

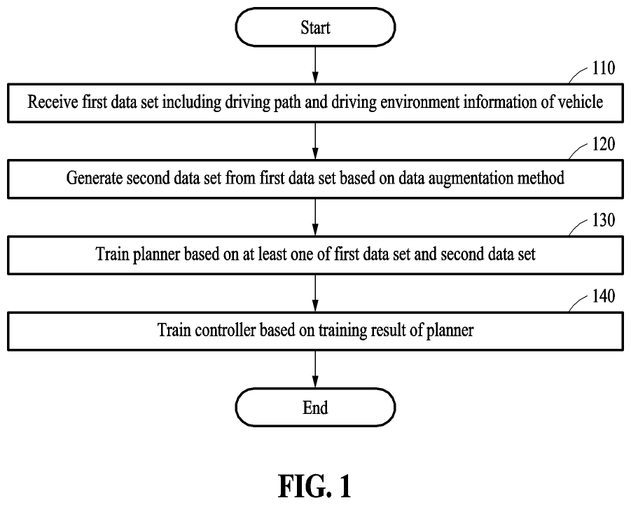

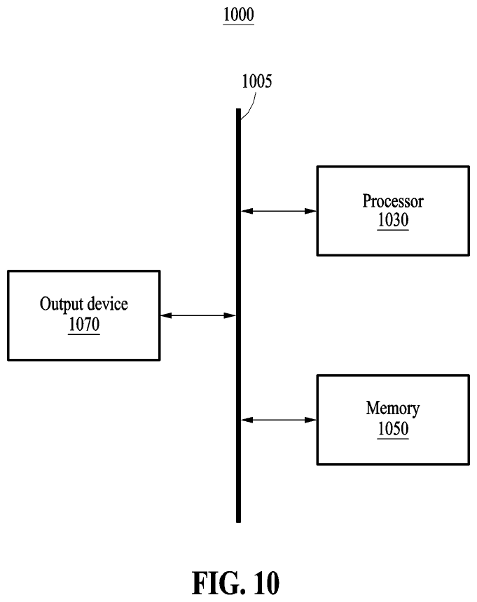

FIG. 1 illustrates an example of a driving path optimization method of a vehicle, according to one or more embodiments. Operations 110 to 140 may be performed by an electronic device 1000 illustrated in FIG. 10 or by another suitable electronic device in a suitable system.

In operation 110, the electronic device 1000 may receive training data including a first data set including a driving path and driving environment information of a vehicle. The data of the first data set may be expert data collected by an arbitrary vehicle and data about an optimal path associated with (e.g., generated based on or captured in association with) the expert data set.

The expert data may have been generated based on driving data of an expert (e.g., driving data collected during driving of a human expert in real-world driving scenarios). Most of the expert may data be stable driving data and various may not include various driving environments. That is, the expert driving paths may be respectively associated only with a limited set of respective driving environments; some potential driving environments may have no corresponding expert driving paths in the expert data set. When an environment in which the vehicle is driven is not included in the expert data set (is outside the distribution of the expert data), errors may occur in generating a target path by a model trained by the expert data set.

An optimal path is a target path generated by a planner (or, driving path planner) included in a vehicle. The planner may include a path generating model, e.g., a neural network model. In general, a planner may be trained to generate a target path of a vehicle, and the training may be based on an expert data set.

A controller may perform reinforcement training based on the optimal path generated by the planner. At the beginning of the reinforcement training of the controller, various experiences may need to be accumulated to improve the autonomous driving performance of the vehicle and thus, early stages of training may be accompanied by unstable vehicle driving. However, such unstable vehicle driving performance may in turn affect the planner. Accordingly, in examples described below, the electronic device 1000 may use a data augmentation method so that such unstable driving situations may be considered in the training process of the planner.

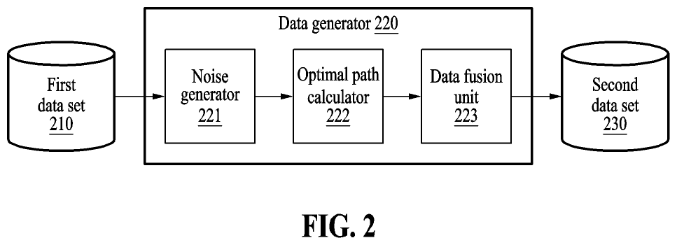

In operation 120, the electronic device 1000 may generate a second data set from the first data set based on a data augmentation method. The electronic device 1000 may generate the second data set from the first data set using a data generator (e.g., the data generator 220 shown in FIG. 2). The data augmentation method may involve augmenting expert data (e.g., expert driving data mentioned above) using an optimization-based path planning technique.

The data augmentation method may add noise to direction, location, speed, and/or acceleration data of the vehicle included in the first data set. The data augmentation may improve generalization performance of a model (e.g., the aforementioned path generating model) by increasing the diversity of training data (e.g., in the second data set). For vehicles that perform autonomous or assisted driving, it may be beneficial to use a variety of pieces of data to be able to respond to various driving conditions and unexpected situations. By adding noise, various initial conditions may be simulated by changing state variables (e.g., direction, location, speed, and acceleration) of the vehicle.

In the description below, noise in the described examples is described assuming that noise is added to the direction and/or posture of the vehicle. However, when responding to unexpected variables during a driving process of the vehicle, there may be rapid changes in acceleration, steering angle, location, and speed of the vehicle, and therefore, noise may be added to improve response to rapid changes in the vehicle through various scenarios. That is to say, other forms of noise (e.g., speed, steering angle, location, etc.) may be added and the following description of noise addition applies to any such type of parameter of the driving process.

The second data set may include optimal path data generated from data to which noise has been added to the first data set (i.e., a noised data set), where the noise is generated based on a vehicle dynamics model and an objective function.

The objective function may induce generation of the optimal path data to minimize an error between a target path changed by noise and an optimal path for the first data set.

The optimal path data according to an example may be generated based on a nonlinear optimization method.

The data generator 220 may generate a data set (e.g., the second data set) to include various scenarios by adding noise into the first data set.

In operation 130, the electronic device 1000 may train the planner (e.g., a driving planner) based on the first data set and/or the second data set. The planner training may be performed based on an open-loop imitation training method.

The electronic device 1000 may use a planner trainer to train the planner based on the first data set (e.g., an existing data set), and the second data set, which is a generated/augmented data set. The training of the planner, which may be supervised, may involve updating the planner (e.g., weights thereof) to minimize the error between a driving path included in the first data set and a target driving path generated by the planner. The supervised training, a type of machine learning, may use input data items and respectively corresponding answers (labels) to train a model. The supervised training may train a function or a model that maps given input data to a correct output value (a label).

The planner training of the electronic device 1000 may be based on an open-loop imitation training method, but accuracy of the target path may also be improved by considering a closed-loop operation.

In operation 140, the electronic device 1000 may train the controller based on a training result of the planner. The controller training may be performed based on a closed-loop reinforcement training method. The closed-loop reinforcement training method may include an implementation of a behavior cloned soft actor-critic (BC-SAC) algorithm.

To train the controller, the electronic device 1000 may use a simulator and may use an agent to interact with the simulator. The agent may include a reinforcement trainer, the planner, and the controller. The planner, when it has been trained, may generate the target driving path based on an observed state of the simulator and may transmit the target driving path to the controller. The controller may generate an operation signal to control driving of the vehicle based on the target driving path and may transmit the operation signal to the simulator. The simulator may update the state by simulation based on the received operation signal and may transmit the updated state and compensation to the agent (as discussed next, there may be multiple agents for which this process is performed). The reinforcement trainer may train the controller based on the updated state of the simulator, the compensation, and the operation signals of the controller.

Agents may represent various respective components of an autonomous driving system. For example, the agents may represent any of various entities that act in a road environment, such as vehicles, pedestrians, and bicycles. To summarize, the autonomous driving vehicle (itself) may be represented by an agent, and surrounding moving objects, such as other vehicles and pedestrians, may also/additionally be represented by agents.

Agents generally act in (or interact with) a provided environment to attain (or move towards attaining) specific goals. The autonomous driving system may be designed to predict movements of these agents and plan movements of the vehicle accordingly.

FIG. 2 illustrates an example of a data generator, according to one or more embodiments.

The description provided with reference to FIG. 1 is generally applicable to FIG. 2.

As shown in FIG. 2, one or more blocks and a combination thereof may be implemented by a special-purpose hardware-based computer that performs a predetermined function, or a combination of computer instructions and general-purpose hardware.

Referring to FIG. 2, the electronic device 1000 may use a data generator 220 to generate a second data set 230 from a first data set 210, which is an expert data set, using a data generator 220.

The data generator 220 according to an example may include a noise generator 221, an optimal path calculator 222, and a data fusion unit 223, which are described next.

The electronic device 1000 may process the first data set 210, which is an initial expert data set, into the form of training data. By inputting map information and a vehicle path (e.g., location, speed, and posture) up to a time t from the first data set 210, a driving path over time may be output. Here, the first data set 210 assumes that there are n+1 agents, the agents including an agent representing an autonomous vehicle. A set of trajectories of any one of the agents (an i-th agent) over a span of time from −N (past), to 0 (present), to M (future) may be expressed as Equation 1 below.

$${X}_{i}^{gt} = \{ {x}_{i}^{gt} ( - N ) , … , {x}_{i}^{gt} ( 0 ) , … , {x}_{i}^{gt} ( M ) \} = {\{ {x}_{i}^{gt} ( k ) \}}_{k = - N}^{M} \qquad Equation 1$$

Here, i denotes an agent index; index i=0 is the index of the agent of the autonomous vehicle. The parentheticals are a time parameter. For the i-th agent, the

$${X}_{i}^{gt}$$

elements of the set to the left of

$${x}_{i}^{gt} ( 0 )$$

denote a past trajectory of N-length, the element

$${x}_{i}^{gt} ( 0 )$$

denotes a current state, and the

$${X}_{i}^{gt}$$

elements after

$${x}_{i}^{gt} ( 0 )$$

denote a future trajectory of M-length. In Equation 1, “gt” denotes ground truth.

The data generator 220 may receive the processed training data (first data set 210) and insert noise generated by the noise generator 221 into the training data. The data generator 220 may generate a noised-state x′(t) by inserting noise into a vehicle state x(t) at time t. The noise may follow a random Gaussian distribution for all state variables, as a non-limiting example.

More specifically, the data generator 220 may insert Gaussian noise into

$${x}_{0}^{gt} ( 0 )$$

(current state of the agent of the autonomous vehicle) and may obtain

$${\hat{x}}_{0}^{gt} ( 0 ) ,$$

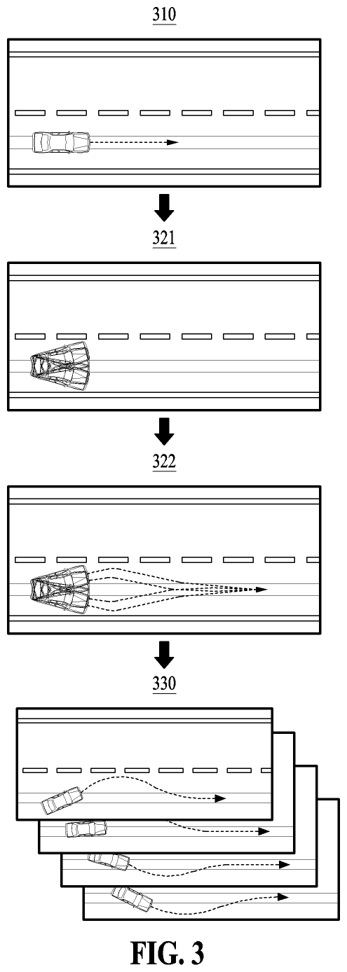

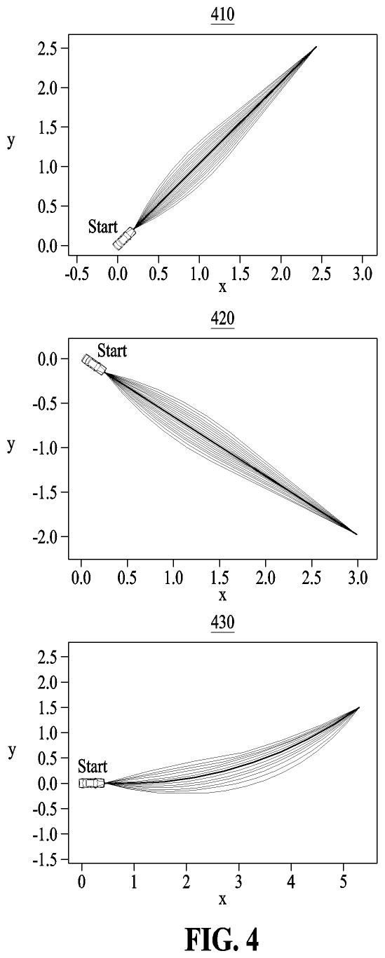

which is a state to which noise has been added, in order to generate various paths from the current state, which is a single state. For example, it may be assumed that a naturally connected path is generated by adding Gaussian noise to the direction of the vehicle θ₀, as shown in Equation 2 (see FIGS. 3 and 4).

$${\hat{x}}_{0}^{gt} ( 0 ) ← {x}_{0}^{gt} ( 0 ) + 𝒩 ( 0 , \sum ) \vert \qquad Equation 2$$

However, noise is not limited to Gaussian distribution as in the described example and noise such as uniform noise may be inserted.

The data generator 220 may calculate an optimal path using the optimal path calculator 222 for training data in which noise is inserted. The optimal path calculator 222 may calculate a nonlinear optimization path by considering a noised initial state x′(t), a vehicle dynamics model, and an objective function. The vehicle dynamics model may be designed considering target plant characteristics and may also be implemented using a data-based dynamics model training method. The objective function may be a function that aims to return the vehicle to the center line of an existing lane as quickly as possible (see FIGS. 3 to 5). The optimal path calculator 222 may output the optimal path as a result of nonlinear optimization processing. As an example of a nonlinear optimization algorithm, an iterative linear-quadratic regulator (ILQR) and sequential linear-quadratic programming (SLQP) may be used.

Regarding the above-mentioned “plant”, in the context of control systems, “plant” refers to a physical system or model being controlled, which, in the embodiments disclosed herein, is the vehicle dynamics model that the planner is optimizing. This terminology is commonly used in engineering and control systems to describe the actual hardware or system that a control algorithm is designed to manage. For example, in autonomous driving, the “plant” is the vehicle itself or a kinematic model of it, as mentioned in the Background. “Plant” above emphasizes that the planner is generating an optimal control path for the actual vehicle system rather than just an abstract path.

The optimal path calculator 222 may use

$${\hat{x}}_{0}^{gt} ( 0 ) ,$$

which is a noised state, as an initial condition, and may perform optimal path calculation using ground truth (gt) trajectory

$${\{ {x}_{0}^{gt} = ( k ) \}}_{k = 0}^{T}$$

as a target trajectory.

The optimization calculation may establish an optimal plan with minimal resources and time to achieve a given goal. More specifically, a state vector of the vehicle x=[x, y, θ, v]^{T} and an input vector u=[a, κ]^{T} may be defined. Here, X and y two-dimensional location, θ denotes direction, v denotes velocity, and a denotes acceleration. A steering curvature κ may be obtained through inverse geometry of a bicycle model and may be used as an input command for steering. The vehicle may need to follow a target trajectory

$${X}_{d} = \{ {x}_{d} ( 0 ) , {x}_{d} ( 1 ) , … , {x}_{d} ( T ) \} = {\{ {x}_{d} ( k ) \}}_{k = 0}^{T} .$$

Here, T denotes the duration of the trajectory. x_{d}(k) is a simplified expression for a target state x_{d}(kΔt) using time index k and time difference Δt. A cost function that needs to be optimized to calculate a prediction interval of T step may be defined as in Equation 3 below.

$$J = {‖ x ( T ) - {x}_{d} ( T ) ‖}_{P}^{2} + {\sum }_{k = 0}^{T - 1} ( {‖ x ( k ) - {x}_{d} ( k ) ‖}_{Q}^{2} + {‖ u ( k ) ‖}_{R}^{2} ) \qquad Equation 3$$

Here, the P, Q, and R matrices denote a terminal state error, a state error of k-th time step, and a weight for control input, respectively.

$${‖ x ‖}_{A}^{2}$$

denotes x^{T}Ax using a positive semi-definite weight matrix A. The optimal path calculation may be performed using a nonlinear optimization technique to minimize a given cost function. An optimal path calculation procedure may be encapsulated as shown in Equation 4.

$$X = O P ( {x}_{0} , {X}_{d} ) \qquad Equation 4$$

Through the above-described optimal path calculation, the optimal path calculator 222 may calculate the noised trajectory \hat{X}₀, as shown in Equation 5 below.

$${\hat{X}}_{0} = O P ( {\hat{x}}_{0}^{gt} ( 0 ) , {\{ {x}_{0}^{gt} ( k ) \}}_{k = 0}^{T} ) = {\{ {\hat{x}}_{0} ( k ) \}}_{k = 0}^{T} \qquad Equation 5$$

The data generator 220 according to an example may fuse the output optimal path with the vehicle path of the first data set 210 using the data fusion unit 223. More specifically, the data generator 220 may fuse a noised trajectory result \hat{X}₀ (obtained from the optimal path calculator 222) with GT trajectory

$${X}_{0}^{gt} .$$

That is, the data generator 220 may fuse

$${\{ {x}_{0}^{gt} ( k ) \}}_{k = 0}^{T} of {X}_{0}^{gt} with {\{ {\hat{x}}_{0} ( k ) \}}_{k = 0}^{T} .$$

Regarding the fusing, fusing may involve including both the generated noised path and the original GT (ground truth) path within the augmented dataset for training purposes. The noised path generated through data augmentation simulates possible variations in vehicle trajectories by introducing controlled perturbations, such as noise in position or orientation, to reflect real-world uncertainties. The GT path serves as a stable reference path captured from expert data without any noise. In the fusion process, both the GT path and the noised path are preserved separately within the dataset. This allows the training model to learn from both stable, predictable trajectories (GT paths) and potentially unpredictable variegated scenarios (noised paths). By incorporating both types of paths into the training dataset, the model can develop robustness across different driving conditions, enhancing its responsiveness to real-world scenarios.

In some implementations, the data generator 220 does not fuse generated paths that are not helpful for training. For example, there may be cases where a generated optimal path collides with surrounding vehicles, deviates from driving lanes, or collides with surrounding objects. In addition, there may be a case where the calculation cost function of the optimal path is not reduced and a low-quality path is generated.

The electronic device 1000 may obtain the second data set 230 in the first data set 210 is augmented with data according to the output result of the data generator 220.

FIG. 3 illustrates an example of data augmentation, according to one or more embodiments.

The description provided with reference to FIGS. 1 and 2 is generally applicable to FIG. 3.

The electronic device 1000 may obtain a driving path 310 according to a time from the first data set 210.

The data generator 220 may generate noise using the noise generator 221. For example, posture permutations 321 (noised postures) of the vehicle may be obtained by adding Gaussian noise (posture noise) to the heading of the vehicle.

The data generator 220 may generate optimal paths 322 for the respectively corresponding noised posture permutations 321 using the optimal path calculator 222. Subsequently, the data generator 220 may output a result by combining (fusing) the generated optimal paths 322 with the first data set 210 and the electronic device 1000 to thereby obtain a second data set 330 augmented with data from various scenarios.

FIG. 4 illustrates an example of data augmentation by noising, according to one or more embodiments.

The description provided with reference to FIGS. 1 to 3 is generally applicable to FIG. 4.

In graphs 410 to 430, the middle solid line represents a driving path extracted from the first data set 210 as a reference trajectory. Dotted lines surrounding the solid line represent noised optimal paths calculated by the optimal path calculator 222 and fused/joined (e.g., added) into the first data set 210. The x-axes and the y-axes of the graphs are coordinate systems expressing location of the corresponding vehicle.

Referring to the graphs 410 to 430, when noises are inserted into a posture of the vehicle, the respectively corresponding optimal paths (e.g. dotted lines) generated from the second data set 230 may be identified (and possibly filtered for suitability), and the various generated paths may consider not only the driving path, which is the reference trajectory, but also surrounding situations, the chance of intersection therewith by a path is increased by the noised paths.

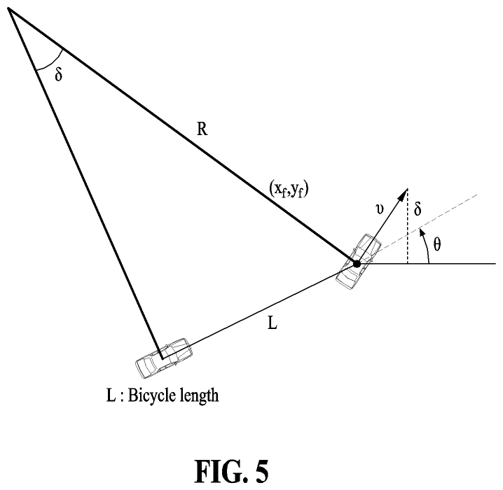

FIG. 5 illustrates an example of a dynamics model of a vehicle, according to one or more embodiments.

The description provided with reference to FIGS. 1 to 4 is generally applicable to FIG. 5, and any repeated description related thereto may be omitted.

A dynamics model mathematically describes movements of an object in a physical system and may mainly represent the relationship between state variables and control inputs of the modeled physical system. The dynamics model may be used to predict and control an operation of the physical system over time.

A vehicle dynamics model may be implemented as, for example, a data-based differentiable dynamics model. Referring to FIG. 5, the vehicle dynamics model may generally be expressed as a two-wheeled bicycle model, as a non-limiting example. The vehicle dynamics model may be implemented with Equations 6 to 8 below.

$$Dynamic Model \dot{x} = {[ x , y , v , θ , δ ]}^{T} \qquad Equation 6$$

$$Control Input u = {[ a , ∅ ]}^{T} \qquad Equation 7$$

$$Dynamic Model \dot{x} = f ( x , u ) = [ \begin{matrix}v cos θ \\ v sin θ \\ a \\ \frac{v tan δ}{L} \\ ∅\end{matrix} ] \qquad Equation 8$$

Here, X, y denote locations of a vehicle, V denotes speed of a vehicle, θ denotes posture (or direction) of a vehicle, δ denotes a steering angle of a vehicle, a denotes acceleration of a vehicle, Φ denotes a steering rate of a vehicle, and L denotes distance between wheels of a vehicle. The bicycle model simplifies modeling of the movement of the vehicle and may be used for autonomous/assisted driving by a planner and a controller by closely imitating the movement of an actual vehicle. A state variable is any variable, for example a vector, representing a current state of a vehicle. A control input is any variable that controls the movement of a vehicle.

An objective function may be implemented as per Equations 9 to 13 below.

$$J ( X ) = {min}_{{u}_{t} , ⋯ , {u}_{t + T}} {\sum }_{i = t}^{t + T} c ( {x}_{i} , {u}_{i} ) \qquad Equation 9$$

$$c ( {x}_{i} , {x}_{i} ) = ‖ {x}_{i} - {x}_{i , ref} ‖ \qquad Equation 10$$

$${x}_{i + 1} = {f}_{d} ( {x}_{i} , {u}_{i} ) \qquad Equation 11$$

$${x}_{t} = {x}_{t , ref} + 𝒩 ( 0 , \sum ) \qquad Equation 12$$

$${u}_{i} < {u}_{max} for i = \{ t , ⋯ , t + T \} \qquad Equation 13$$

Here, T denotes time horizon, x_{i, ref} denotes a reference path, Σ denotes noise variance, uₘₐₓ denotes input constraint. f_{d} denotes a dynamic model. The reference path represents a path the vehicle needs to follow and generally refers to a target location and a state that needs to be reached at a given time i. The noise variance may be noise variance added to the state variable. The noise variance may model uncertainty that may occur in an actual driving environment of the vehicle. The input constraint may be a maximum value of the control input.

The objective function may help derive an optimal driving path of the vehicle to minimize costs over a given time horizon. Here, Equation 5 is a cost function and may refer to an error between the state variable and the control input.

The optimal path calculator 222 of the data generator 220 may model state changes of the vehicle using the dynamics model for the state variables and the control input of the vehicle, may set an optimization goal using the objective function, may then use a nonlinear optimization method to calculate the optimal path, and may obtain a data set including optimal path data from the data set to which noised is added.

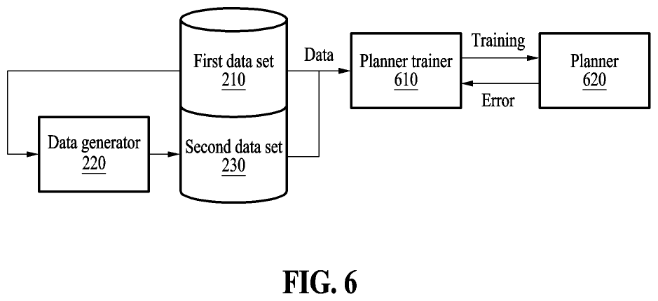

FIG. 6 illustrates an example of training a planner, according to one or more embodiments.

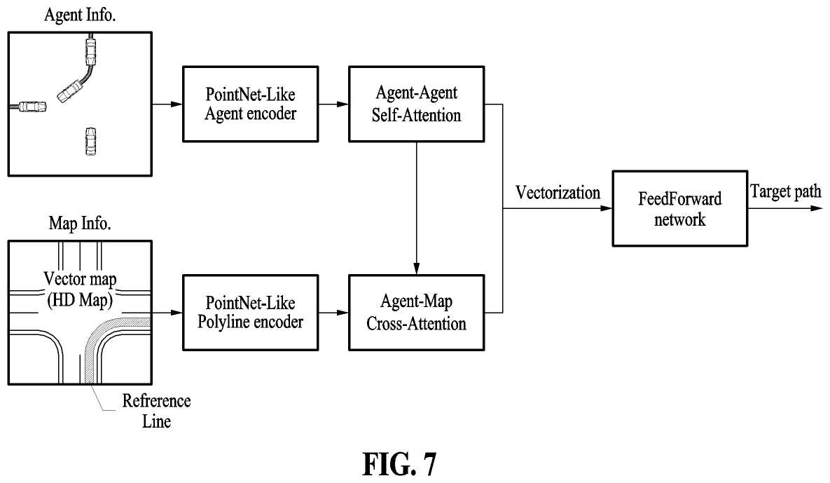

FIG. 7 illustrates an example of operating a planner, according to one or more embodiments.

The description provided with reference to FIGS. 1 to 5 is generally applicable to FIGS. 6 and 7.

Referring to FIG. 6, the electronic device 1000 may train a planner 620 based on the first data set 210 and/or the second data set 230 using a planner trainer 610. When the electronic device 1000 trains prediction about surrounding agents, the electronic device 1000 may improve the performance of the planner 620 by training interactions with the surrounding agents.

Referring to FIG. 7, input of the planner 620 may be agent information, autonomous driving-centered map information, and a traffic signal state, as non-limiting examples. The planner 620 may encode agent information using a point net-like agent encoder. The planner 620 may encode map information with a point net-like polyline encoder. The planner 620 may perform self-attention using encoded agent feature information and may perform cross-attention using the encoded agent feature information and feature information of a map. The feature information on which attention is performed may be vectorized and passed through a feed forward network to generate a target path, which is an optimal path.

The electronic device 1000 may train the planner 620 using the target path output from the planner 620 through the planner trainer 610 that may implement a loss function as shown in Equation 14 below.

$$ℒ = {w}_{1} \frac{1}{n} {\sum }_{i = 1}^{n} {‖ {X}_{i} + {X}_{i}^{gt} ‖}^{2} + {w}_{2} {‖ {X}_{0} + {\hat{X}}_{0}^{gt} ‖}^{2} \qquad Equation 14$$

Here, w₁ and w₂ denote a surrounding agent prediction item and a weight assigned to the planner 620, respectively.

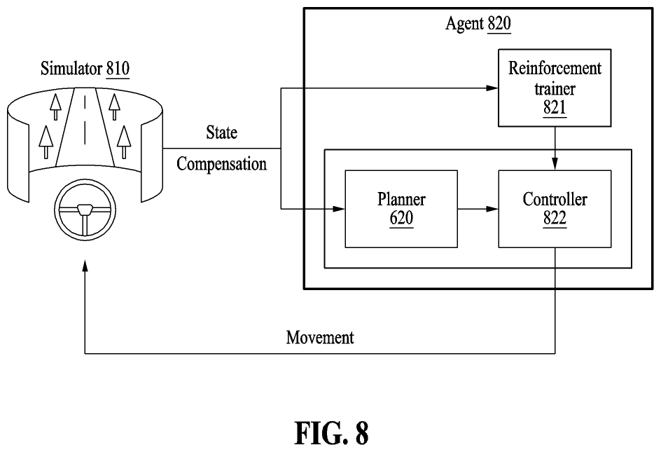

FIG. 8 illustrates an example of training a controller, according to one or more embodiments.

The description provided with reference to FIGS. 1 to 7 is generally applicable to FIG. 8 and accordingly, a repeated description related thereto is omitted.

Referring to FIG. 8, the electronic device 1000 may train a simulator 810 and a controller 822 using the previously trained planner 620 and a reinforcement trainer 821 included in an agent 820 in the above-described method.

The controller 822 may be implemented with multilayer perceptron (MLP). The controller 822 may be trained using BC-SAC. The controller 822 may be trained by receiving data about a target path from the previously trained planner 620. Subsequently, the electronic device 1000 may reflect a result (e.g., an operation signal) output from the controller 822 to the simulator 810 and may transmit an updated state and compensation from the simulator 810 back to the agent 820.

The simulator 810 may simulate various driving environments and scenarios of an autonomous vehicle. Accordingly, dangerous situations that may occur on real roads may be virtually reproduced and sensor data and operations of the vehicle may be verified. The simulator 810 may allow repetitive testing and may improve performance and stability of a model. A simulation result repeatedly performed in the simulator 810 may be stored in a replay buffer B.

The described example initiates control policy training in a continuous movement space when performing reinforcement training. A reinforcement training issue may be defined as a tuple {S, A, T, r, γ, ρ0}. A state space S and a movement space A are assumed to be continuous. A state transition model T denotes a probabilistic mapping from a current state sₜ ∈S and movement aₜ ∈A to a next state sₜ₊₁ ∈S. r denotes a reward function, γ denotes a discount factor, and ρ0 denotes an initial state distribution.

When the reinforcement trainer 821 performs reinforcement training, BC-SAC may improve reinforcement training stability compared to an original actor-critic algorithm through entropy maximization. The described examples may use BC-SAC for continuous control policy training in reinforcement training, which may be a combination of imitation learning (IL) and soft actor-critic (SAC). The goal of BC-SAC may be expressed as a weighted mixture of reinforcement learning (RL) and IL goals, as shown in Equation 15 below.

$${max}_{π} {𝔼}_{𝒯 , {πρ}_{0}} [ {\sum }_{t = 0}^{∞} {γ}^{t} r ( {s}_{t} , {a}_{t} ) ] + λ {𝔼}_{s , a \sim 𝒟} [ log π ( a \vert s ) ] \qquad Equation 15$$

A demo replay buffer D={s, a, s′} is extracted from an expert data set, and an experience replay buffer B={s, a, r(s, a), s′} may be accumulated through a closed-loop simulation of the simulator 810. An actor-critic algorithm may train a critic Q to reduce a Bellman error and may alternately perform two operations of training an actor π to maximize a value function. In SAC, an entropy normalization update may be performed with entropy H, as shown in Equations 16 to 18 below.

$$Actor objective {max}_{π} {𝔼}_{s , a ∼ π} [ Q ( s , a ) + ℋ ( π ( \cdot \vert s ) ) ] + {λ𝔼}_{s , a ∼ 𝒟} [ log π ( a \vert s ) ] \qquad Equation 16$$

$$Critic objective {min}_{Q} {𝔼}_{s , a , {s}^{′} ∼ π} [ {( Q ( s , a ) - \hat{Q} ( s , a , {s}^{′} ) )}^{2} ] \qquad Equation 17$$

$$TD target \hat{Q} ( s , a , {s}^{′} ) = r ( s , a ) + {γ𝔼}_{{a}^{′} ∼ π} [ \overline{Q} ( {s}^{′} , {a}^{′} ) - log π ( {a}^{′} \vert {s}^{′} ) ] \qquad Equation 18$$

Here, Q̅ denotes a target network of an original Q in which a gradation does not pass.

More specifically, the reinforcement trainer 821 may train the controller 822 by performing closed-loop reinforcement training. The closed-loop reinforcement training may perform a closed-loop simulation to fill the replay buffer B, a state s is {plan, vectorized map, goal point}, and a movement a is equal to u. A replay stored in the replay buffer B may be a replay about a driving simulation generated during the closed-loop simulation process.

Here, the compensation function r may be defined as Equation 19 below.

$$r = {w}_{co} {r}_{collision} + {w}_{o} {r}_{offroad} + {w}_{ce} {r}_{centerline} + {w}_{g} {r}_{goal} \qquad Equation 19$$

r_{collision} denotes a penalty for collision between agents, r_{offroad} denotes a penalty imposed on the model when the autonomous vehicle deviates from a designated road, r_{centerline} denotes a reward given to the model when the autonomous vehicle is close to the center of a lane, and r_{goal} denotes a reward given when an L2 distance to the final target point is below a predetermined threshold. In addition, a weight for each reward item w{co,o,ce,g} may be assigned. A BC-SAC actor network π_{ϕ} and double critic networks Q_{θ}_{₁}, Q_{θ}_{₂} may be trained using B accumulated during the closed-loop simulation and D extracted from data sets.

In BC-SAC, since balancing a training ratio of IL and RL may affect training performance, the reinforcement trainer 821 may need to use a quality filter (Q-filter). For D={s, a, s′}, the Q-filter may backpropagate a loss only when Q evaluates a better than π_{ϕ}(s). The reinforcement trainer 821 may employ a modified Q-filter due to high state dimensions and complex interactions of surrounding environments of the vehicle. Therefore, the reinforcement trainer 821 may apply the modified Q-filter to a BC loss function L_{BC} as shown in Equation 20 below.

$${ℒ}_{BC} = {\sum }_{i = 1}^{{N}_{D}} {‖ {π}_{ϕ} ( {s}_{i} ) - {a}_{i} ‖}^{2} {𝟙}_{( ( {Q}_{{θ}_{1}} ( {s}_{i} , {a}_{i} ) > {Q}_{{θ}_{1}} ( {s}_{i} , π ( {a}_{i} ) ) ) \cdot ( {Q}_{{θ}_{2}} ( {s}_{i} , {a}_{i} ) > {Q}_{{θ}_{2}} ( {s}_{i} , π ( {a}_{i} ) ) ) )} \qquad Equation 20$$

That is, the modified Q-filter may propagate the BC loss under more conservative conditions by using two critical networks in a training framework. Through this process, the stability of model training may be improved.

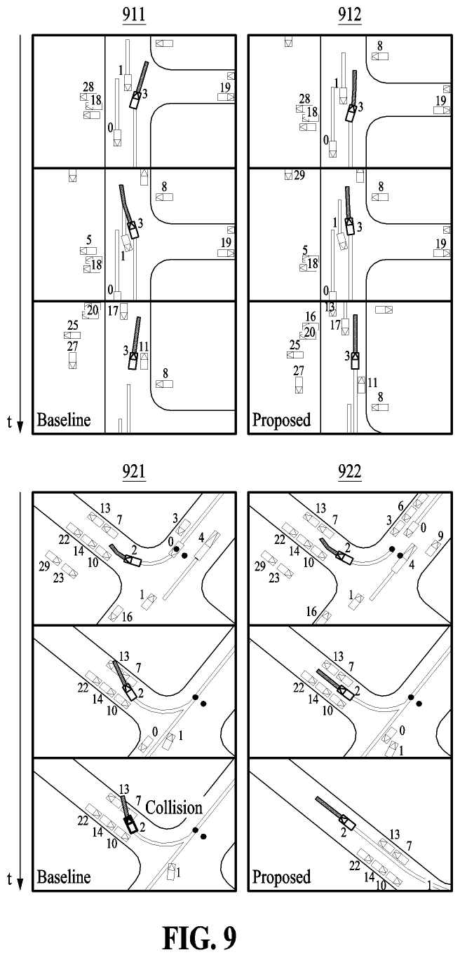

FIG. 9 illustrates an example simulation result by using a driving path optimization method of a vehicle, according to one or more embodiments.

The description provided with reference to FIGS. 1 to 8 is generally applicable to FIG. 9, and any repeated description related thereto may be omitted.

A first simulation 911 and a second simulation 912 are simulations about a situation in which an oncoming vehicle suddenly turns left and blocks a path of an ego vehicle. Sudden intervention by another vehicle may force a posture of the ego vehicle to become unstable. It may be confirmed in the first simulation 911 using a conventional technique that the path to the center line is not recovered when the posture of the ego vehicle is shaken, and thus, the posture of the ego vehicle may not become stable. However, in the second simulation 912, it may be confirmed that the posture of the ego vehicle is controlled due to the effect of reinforcement training on a controller and the path to the center line is maintained.

A third simulation 921 and a fourth simulation 922 may be simulations about a situation in which an ego vehicle needs to avoid vehicles stopped on the shoulder when the ego vehicle attempts to turn right. Due to a distribution of a general expert data set, turning driving data may be less than straight driving data, and thus, path prediction for turning may be difficult. It may be confirmed in the third simulation 921 that a collision occurs since the posture of the ego vehicle is shaken and control stability for rotation of the vehicle is not restored. However, in the fourth simulation 922, it may be confirmed that the ego vehicle moves to the left of the center line and passes through a narrow passageway to avoid vehicles stopped on the shoulder.

Although mathematical notation is used above, it will be appreciated that the described mathematics/algorithms are not the direct subject of this disclosure. Rather, the mathematical notation is a convenient and efficient language used to describe actual operations of actual computing hardware; equivalent text description is possible but would be significantly verbose and difficult to understand. Given the mathematical notation (and variations thereof), an ordinary engineer may devise source code analogous to the mathematical notation and compile the source code into machine-executable instructions that, when executed by processing hardware, cause the processing hardware to perform physical operations that may mirror the mathematical notation. Similarly, an engineer may design and construct, using high-level hardware construction tools, integrated circuits, FPGA circuits, or the like, that are configured to operate as described by the mathematical notation.

FIG. 10 illustrates an example electronic device, according to one or more embodiments.

Referring to FIG. 10, an electronic device 1000 may include a processor 1030 (in practice, one or more processors), a memory 1050, and an output device 1070 (e.g., a display). The processor 1030, the memory 1050, and the output device 1070 may be connected to one another through a communication bus 1005.

The output device 1070 may output a driving path of the vehicle and a simulation result using a planner and a controller trained by the processor 1030.

The memory 1050 may store instructions required for training operations performed by the processor 1030. In addition, the memory 1050 may store various pieces of information generated in the process of the processor 1030 described above. In addition, the memory 1050 may store various pieces of data, programs, and the like. The memory 1050 may include volatile memory or non-volatile memory. The memory 1050 may include a massive storage medium, such as a hard disk, and store the various pieces of data.

In addition, the processor 1030 may perform at least one method described with reference to FIGS. 1 to 9 or an algorithm corresponding to the at least one method. The processor 1030 may be a data processing device implemented by hardware including a circuit having a physical structure to perform desired operations. For example, the desired operations may include code or instructions in a program. The processor 1030 may be implemented as, for example, a central processing unit (CPU), a graphics processing unit (GPU), a neural network processing unit (NPU), or the like (or combinations thereof). The hardware-implemented electronic device 1000 may include, for example, a microprocessor, a CPU, a processor core, a multi-core processor, a multiprocessor, an application-specific integrated circuit (ASIC), and a field-programmable gate array (FPGA).

The processor 1030 may execute a program and control the electronic device 1000. The code of the program executed by the processor 1030 may be stored in the memory 1050.

The processor 1030 may receive the first data set 210 including the driving path of the vehicle and driving environment information, may generate the second data set 230 from the first data set 210 based on a data augmentation method, may train the planner based on the first data set 210 and/or the second data set 230, and may train the controller based on the training result of the planner.

In addition, a vehicle that may perform autonomous driving may include a planner and a controller trained by using the above-described methods.

The examples described herein may be implemented using a hardware component, a software component (instructions), and/or a combination thereof. A processing device may be implemented using one or more general-purpose or special-purpose computers, such as, for example, a processor, a controller and an arithmetic logic unit (ALU), a digital signal processor (DSP), a microcomputer, an FPGA, a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include instructions in the form of a computer program, a piece of code, or combinations thereof, to instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The computing apparatuses, the vehicles, the electronic devices, the processors, the memories, the image sensors, the vehicle/operation function hardware, the ADAS/AD systems, the displays, the information output system and hardware, the storage devices, and other apparatuses, devices, units, modules, and components described herein with respect to FIGS. 1-10 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-10 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A driving path optimization training method of a vehicle, the driving path optimization training method comprising:
receiving a first data set including a driving path and an associated driving environment information;
generating a second data set from the first data by performing data augmentation on the first data;
training a driving path planner based on the second data set; and
training a driving controller based on a training result of the training of the driving path planner.

2. The driving path optimization training method of claim 1, wherein
the first data set comprises an expert data set collected by an arbitrary vehicle and data about an optimal path associated with the expert data set.

3. The driving path optimization training method of claim 1, wherein
the performing the data augmentation comprises adding noise to a posture, a location, a speed, a steering angle, a steering rate, or acceleration data of the vehicle included in the first data set.

4. The driving path optimization training method of claim 1, wherein
the second data set comprises optimal paths generated based on data to which noise is added to the first data set, based on a vehicle dynamics model and an objective function.

5. The driving path optimization training method of claim 4, wherein
the objective function induces generation of the optimal paths to minimize an error between a target path of the vehicle changed by the noise and an optimal path for the first data set.

6. The driving path optimization training method of claim 4, wherein
the optimal paths are generated based on a nonlinear optimization method.

7. The driving path optimization training method of claim 1, wherein
the training of the driving path planner comprises performing training of the driving path planner based on an open-loop simulation training method.

8. The driving path optimization training method of claim 1, wherein
the training of the driving controller comprises performing training of the driving controller based on a closed-loop reinforcement training method.

9. The driving path optimization training method of claim 8, wherein
the closed-loop reinforcement training method comprises a behavior cloned soft actor-critic (BC-SAC) algorithm.

10. A non-transitory computer-readable storage medium storing instructions that, when executed by a processor, cause the processor to perform the method of claim 1.

11. An electronic device, comprising:
a memory storing instructions; and
one or more processors,
wherein the instructions, when executed by the one or more processors, cause the one or more processors to:
receive a first data set including a driving path and an associated driving environment information;
generate a second data set from the first data set by performing data augmentation on the first data set;
train a driving path planner based on the second data set; and
train a driving controller based on a training result of the driving path planner.

12. The electronic device of claim 11, wherein
the first data set comprises an expert data set collected by an arbitrary vehicle and data about an optimal path associated with the expert data set.

13. The electronic device of claim 11, wherein
the performing the data augmentation comprises adding noise to a posture, a location, a speed, a steering angle, a steering rate, or acceleration data of a vehicle included in the first data set.

14. The electronic device of claim 11, wherein
the second data set comprises optimal paths generated based on data to which noise is added to the first data set, based on a vehicle dynamics model and an objective function.

15. The electronic device of claim 14, wherein
the objective function induces generation of the optimal path data to minimize an error between a target path of a vehicle changed by the noise and an optimal path for the first data set.

16. The electronic device of claim 14, wherein
the optimal paths are generated based on a nonlinear optimization method.

17. The electronic device of claim 11, wherein
the instructions, when executed by the one or more processors, cause the one or more processors to perform training of the driving path planner based on an open-loop imitation training method.

18. The electronic device of claim 11, wherein
the instructions, when executed by the one or more processors, cause the one or more processors to perform training of the driving controller based on a closed-loop reinforcement training method.

19. The electronic device of claim 18, wherein
the closed-loop reinforcement training method comprises a behavior cloned soft actor-critic (BC-SAC) algorithm.

20. A vehicle comprising:
a memory storing instructions; and
one or more processors configured by the instructions to execute a driving path planner and a driving controller,
wherein the driving path planner is configured to:
receive a first data set including a driving path and an associated driving environment information;
generate a second data set from the first data set by performing data augmentation on the first data set; and
be trained based on the second data set; and
wherein the driving controller is configured to be trained based on the driving path planner as trained based on the second data set.
